(19) United States
(12) Patent Application Publication
(10) Pub. No.: US 2018/0302348 A1
(43) Pub. Date: Oct. 18, 2018

(54) System And Method For Parsing A Natural Language Communication From A User And Automatically Generating A Response

(71) Applicant: FastForward. ai, Inc., Mountain View, CA (US)

(72) Inventors: Romeo Ganescu, Den Haag (NL); Anton Zubets, Amstelveen (NL); Denis Olegovich Yantarev, Moscow (RU)

(21) Appl. No.: 15/951,161

(22) Filed: Apr. 11, 2018

Related U.S. Application Data
(60) Provisional application No. 62/485,244, filed on Apr. 13, 2017.

(51) Int. Cl. H04L 12/58; G06F 17/30; G06F 17/27; H04W 4/14; G06F 9/54

(52) U.S. Cl. CPC H04L 51/02; G06F 17/30654; G06F 9/54; G06F 17/2705; H04W 4/14; G06F 17/30722

(57) ABSTRACT

This invention relates to a system for receiving and parsing communications from users over multiple channels using knowledge libraries, and in some instances, artificial intelligence, and automatically generating a response that optionally comprises data retrieved from one or more servers.

### PRIORITY CLAIM

This application claims priority under 35 U.S.C. Section 119(e) to U.S. Provisional Application No. 62/485,244, filed on Apr. 13, 2017, and titled “System and Method for Parsing a Natural Language Communication from a User and Automatically Generating a Response Using Knowledge Libraries, an Artificial Intelligence Engine, and Data Retrieved from One or More Servers,” which is incorporated herein by reference.

### TECHNICAL FIELD

This invention relates to a system for receiving and parsing communications from users over multiple channels using knowledge libraries, and in some instances, artificial intelligence, and automatically generating a response that optionally comprises data retrieved from one or more servers.

### BACKGROUND OF THE INVENTION

In the prior art, large companies often provide their customers with options for communicating electronically, such as through electronic chat services and similar mechanisms. Electronic chat services are staffed by a customer service representative (i.e., a person) who engages in a live textual, video, and/or audio chat with User X over a communication medium, such as a messaging system. This often is a time-consuming and tedious process for the customer and the customer service representative, because the customer often needs to wait for several minutes and/or navigate through a series of events in order to engage in the chat session with the customer service representative.

The prior art includes automated “bot” systems that will respond to a customer message without input from a customer service representative. However, these systems are extremely limited in the functionality they can provide and do not offer the flexibility and capability that a customer service representative can provide.

What is needed is a system that can communicate with a user immediately, receive messages from the user, parse the messages, and generate an intelligent response to the messages using knowledge libraries and/or artificial intelligence. What is further needed is the ability for the system to obtain data from a plurality of different servers, using public or private APIs (application program interfaces) or other mechanisms, and to integrate that data into the automatically-generated response sent to the user over the channel used by the user.

### SUMMARY OF THE INVENTION

This invention relates to a system for receiving and parsing communications from users over multiple channels using knowledge libraries, and in some instances, artificial intelligence, and automatically generating a response that optionally comprises data retrieved from one or more servers.

### BRIEF DESCRIPTION OF THE DRAWINGS

FIG. 1 depicts an embodiment comprising a core engine that interfaces with user channels, third-party servers, enterprise servers, and an artificial intelligence engine.

FIG. 2 depicts further details of the core engine, user channels, enterprise servers, and artificial intelligence engine.

FIG. 3 depicts further details of the core engine and user channels.

FIG. 4A depicts further details of the core engine.

FIG. 4B depicts further details of the user channels.

FIG. 4C depicts further details of the artificial intelligence engine.

FIG. 4D depicts further details of the enterprise servers.

FIG. 4E depicts further details of the third-party servers.

FIG. 5 depicts an exemplary method using the system of FIGS. 1-4.

FIG. 6 depicts an exemplary communication session using a mobile device and the embodiments of FIG. 1-5 or 11-16.

FIG. 7 depicts an exemplary communication session using a mobile device and the embodiments of FIG. 1-5 or 11-16.

FIG. 8 depicts an exemplary communication session using a mobile device and the embodiments of FIG. 1-5 or 11-16.

FIG. 9 depicts an exemplary communication session using a mobile device and the embodiments of FIG. 1-5 or 11-16.

FIG. 10 depicts another embodiment comprising a core engine that interfaces with user channels, third-party servers, enterprise servers, and a natural language understanding engine.

FIG. 11 depicts further details of the core engine, user channels, enterprise servers, and natural language understanding engine.

FIG. 12 depicts further details of the core engine and user channels.

FIG. 13A depicts further details of the core engine.

FIG. 13B depicts further details of the user channels.

FIG. 13C depicts further details of the natural language understanding engine.

FIG. 13D depicts further details of the enterprise servers.

FIG. 13E depicts further details of the third-party servers.

FIG. 14 depicts an exemplary method using the system of FIGS. 10-13.

FIG. 15 depicts an exemplary PULL method using the system of FIGS. 10-13.

FIG. 16 depicts an exemplary PUSH method using the system of FIGS. 10-13.

### DETAILED DESCRIPTION OF THE PREFERRED EMBODIMENTS

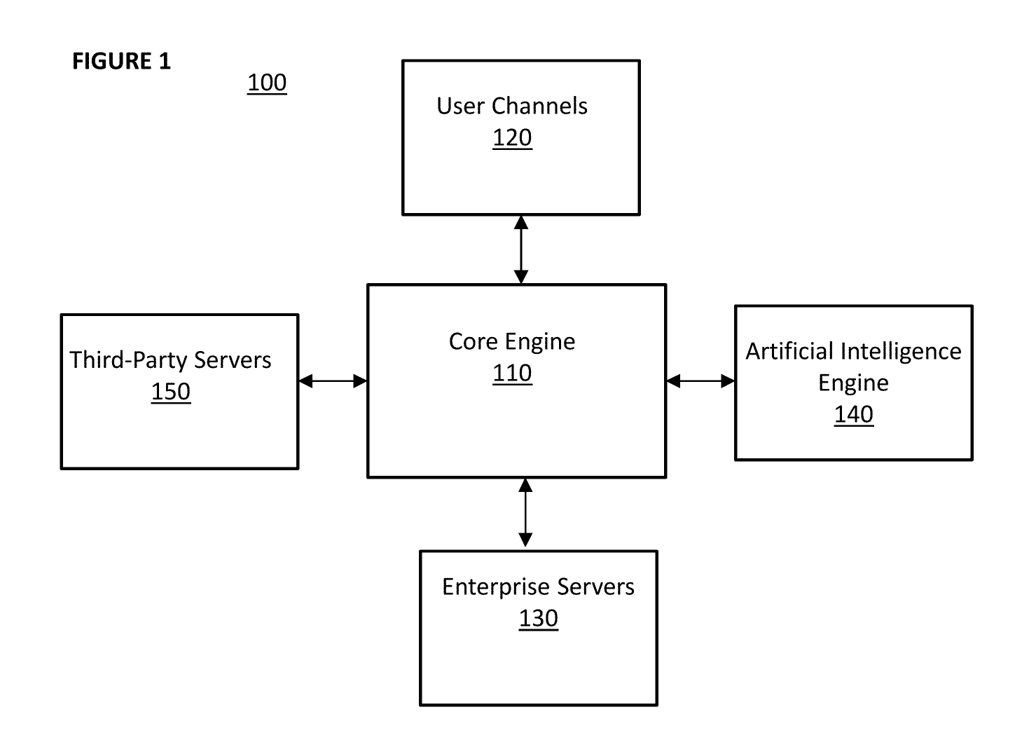

Referring to FIG. 1, communication system 100 comprises core engine 110 that interfaces with user channels 120, third-party servers 150, enterprise servers 130, and artificial intelligence engine 140 over one or more networks and/or links.

Core engine 110 comprises lines of software code executed on one or more servers, each server comprising one or more processing units, memory, non-volatile storage (such as one or more disk drives or flash memory arrays), and a network interface.

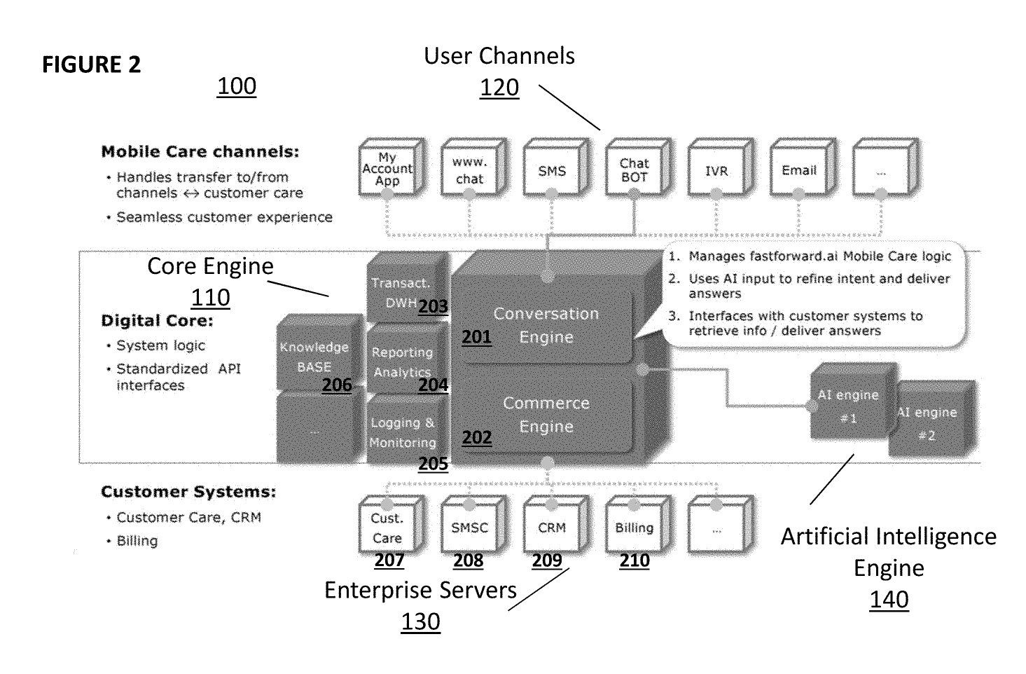

Referring to FIG. 2, additional detail is shown for communication system 100. Each channel within user channels 120 comprises a user device (such as a mobile device or laptop or desktop computer) and a communication mechanism by which a user communicates with core engine 110. Examples of communication mechanisms include software applications (“apps”), web-based chat features, SMS or MMS messaging, email, voice, or other known mediums.

Core engine 110 optionally comprises conversation engine 201, commerce engine 202, transaction data warehouse 203, reporting analytics engine 204, logging and monitoring engine 205, knowledge base 206, and other modules or engines.

Artificial intelligence engine 140 can comprise one or more engines running one on or more servers that operate independently or in concert with one another. Examples of artificial intelligence engines include an artificial intelligence engine developed by the Applicant, the “Watson” engine by IBM, and the API.ai engine by Google.

Enterprise servers 130 are enterprise servers typically operated by a large company to run its business activities. For purposes of illustration, we will assume that enterprise servers 130 in the embodiments are operated by or for Company Y. Examples of enterprise servers 130 include customer care server 207, SMSC (short message server center) server 208, CRM (customer relationship management) server 209, billing server 210, and other servers.

Third-party servers 150 are not shown in FIG. 2.

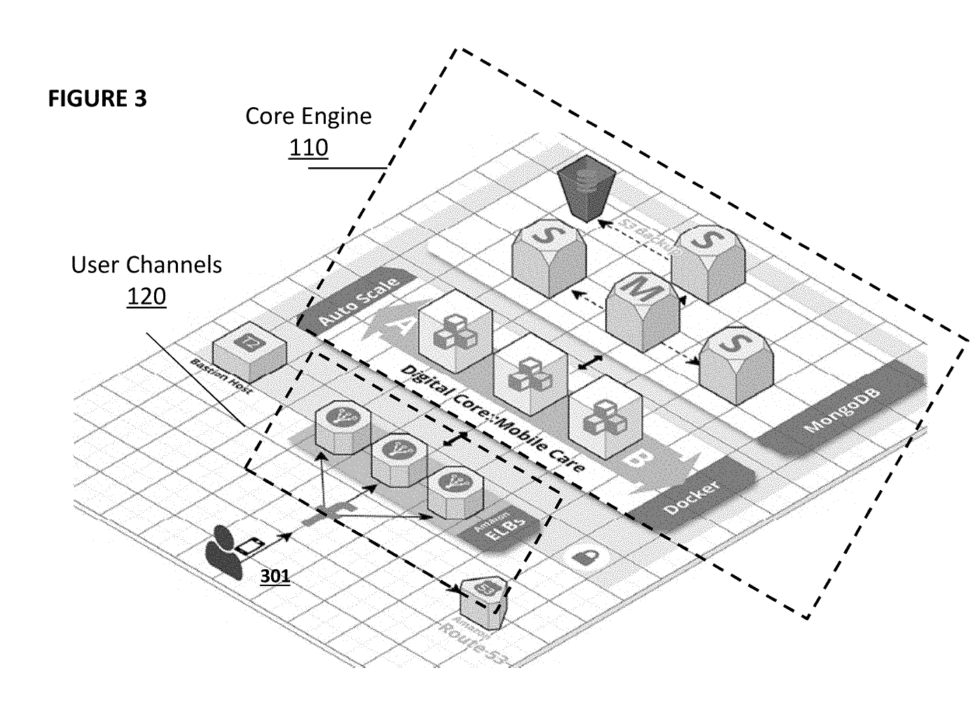

Referring to FIG. 3, additional detail is shown of certain aspects of communication system 100. A user operates computing device 301 (such as a mobile device) and interacts user channels 120 with one or more of the mechanisms described previously, such as a chat app. User channels 120 are implemented by servers as depicted. Core engine 110 is implemented by servers and database units as depicted. For purposes of illustration, the embodiments described herein will involve User X as a typical user.

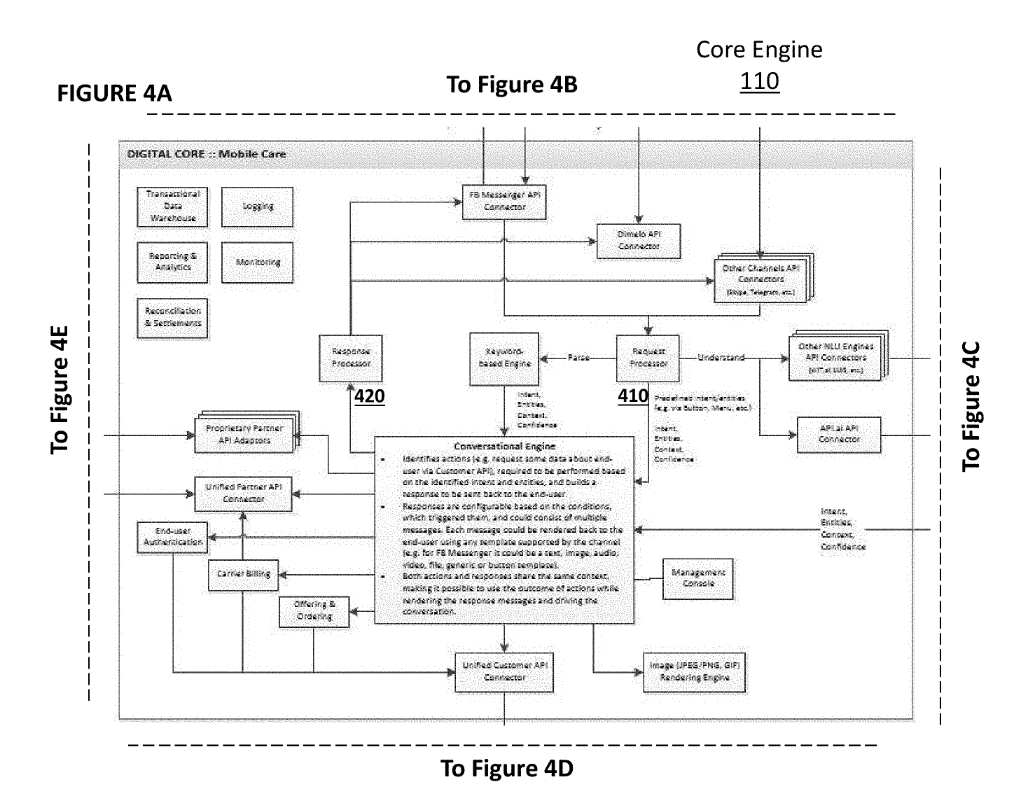

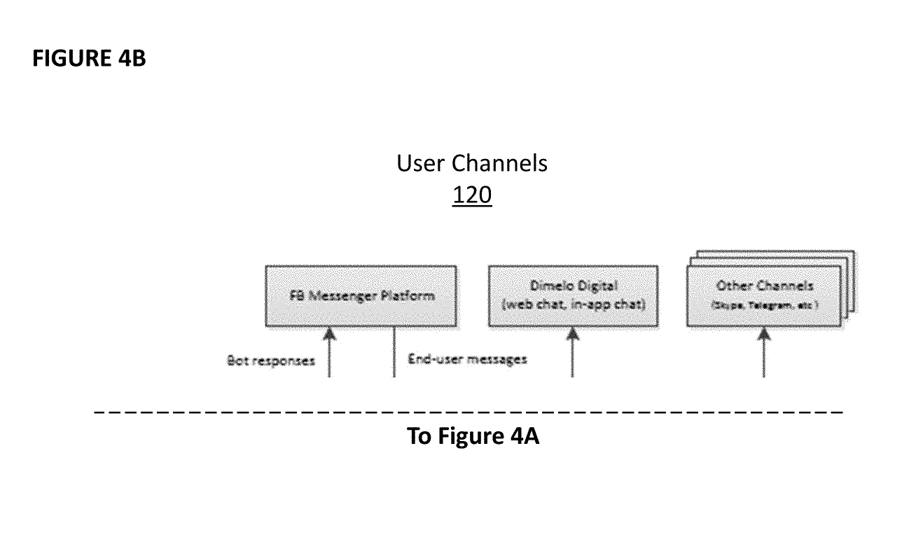

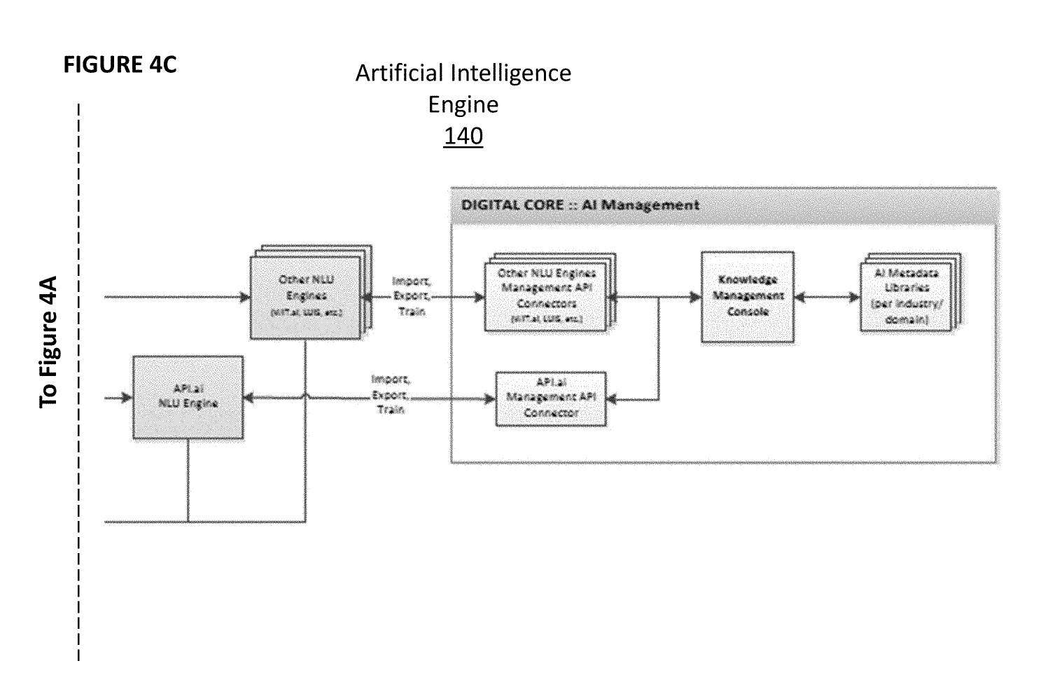

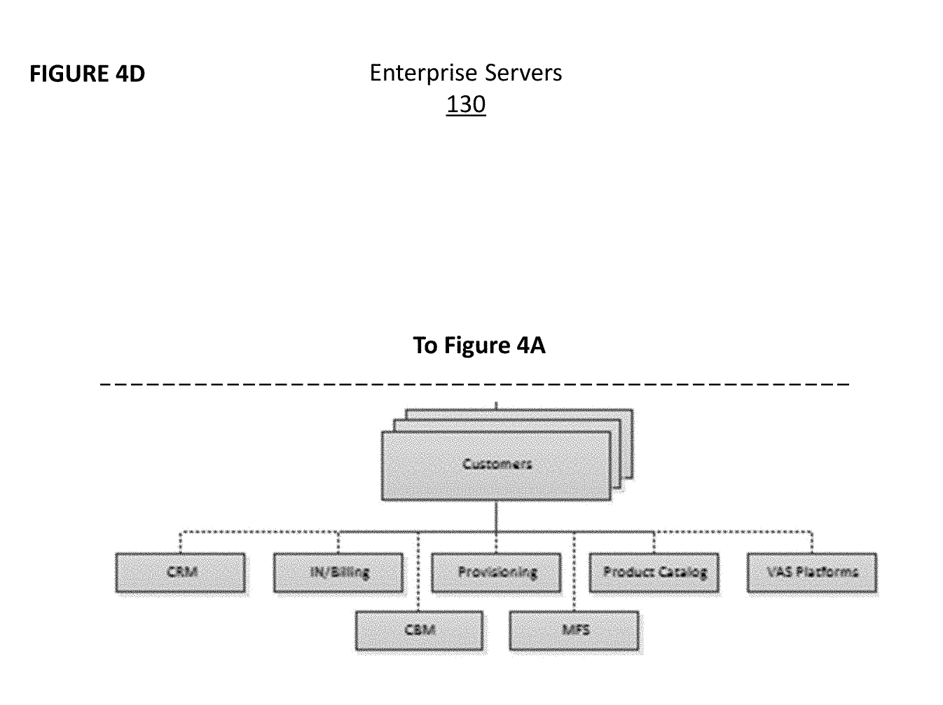

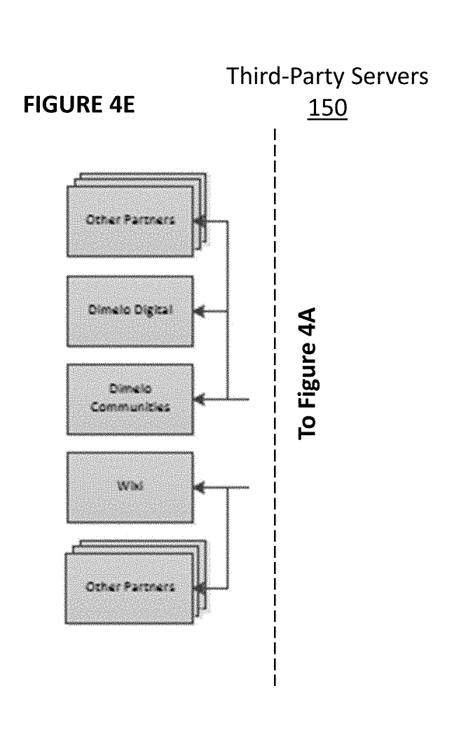

FIGS. 4A, 4B, 4C, 4D, and 4E depict additional details regarding communication system 100. FIG. 4A depicts exemplary details of core engine 110, FIG. 4B depicts exemplary details of user channels 120, FIG. 4C depicts exemplary details of artificial intelligence engine 140, FIG. 4D depicts exemplary details of enterprise servers 130, and FIG. 4E depicts exemplary details of third-party servers 150.

In FIG. 4B, a user engages in communication over facebook Messenger Platform, which is an example of a software app that provides a messaging service that can communicate with core engine 110, or other exemplary channels as shown. User X will initiate communication with Company Y. From User X's point of view, he or she is attempting to communicate with a customer service representative of Company Y. Company Y might be, for example, a bank, credit card company, phone company, utilities company, airline, or any other type of company. Company Y might be the operator of core engine 110 or it might have hired another company to operate core engine 110 on its behalf. Thus, instead of actually communicating with a customer service representative, User X will communicate with core engine 110.

In FIG. 4A, core engine 110 communicates with user channels 120. Core engine 110 comprises connectors for communicating with each mechanism potentially operated by User X, such as a facebook Messenger API connector. This allows core engine 110 to receive the same communications from User X that a customer service representative typically would receive.

The communications received from User X are provided to request processor 410. Request processor 410 will determine if it understands the communication from User X with a degree of certainty that is above a predetermined, acceptable threshold (such as 95% certainty). If User X's communication is similar to other communications that have been received and responded to in the past, such as “What is my balance?”, request processor 410 will be able to determine the intent of this communication using knowledge libraries 206. Knowledge libraries 206 can comprise one or more databases or files that correlate customer intent with language. Knowledge libraries 206 can be built over time based on actual interactions with customers. Examples of language and associated intent are shown in Table 1:

TABLE 1

| Language | Intent |
|---|---|
| Balance | User Y account balance |
| Payment Due | User Y account payment deadline |
| Account Type | User Y account type parameters |
| Usage | User Y account usage of specific Company Y |
| | services |
| Tariff | User Y account tariff info specific to |
| | Company Y services |

If request processor 410 is able to determine User X's intent with a degree of certainty above the acceptable threshold based on the communication and knowledge libraries 206, then it can act without communicating with artificial intelligence engine 140. However, if request processor 410 is unable to understand the communication with a degree of certainty above the acceptable threshold, it will engage with interfaces to artificial intelligence engine 140.

In FIG. 4C, artificial intelligence engine 140 will receive the User X communication from core engine 140 and will perform artificial intelligence algorithms on the communication to determine the intent of the communication. Artificial intelligence engine 140 then will send a communication to core engine 110 indicating the intent of User X communication (e.g., “Balance of Bank Account”). Exemplary input sets sent to artificial intelligence engine 140 and exemplary outputs received from artificial intelligence engine 140 are contained in Table 2:

TABLE 2

| | Output (Intent of |
|---|---|
| Input (User X Communication) | User X Communication) |
| What is my balance? | account balance |
| When is my bill due this month? | account payment deadline |
| How many minutes I consumed so far? | minute resource usage |
| What's to cost to call Italy? | International destination cost |

In FIG. 4B, core engine 110—either through its own understanding without engaging with artificial intelligence engine 140 or through communications with artificial intelligence engine 140—will determine actions it needs to take to service User X's communication, which may involve communicating with enterprise servers 130. For example, core engine 110 might initiate a query to one of enterprise servers 130 through an API or other mechanism.

In FIG. 4D, enterprise servers 130 receive a query (e.g., an API request to obtain balance of account for User X) from core engine 110 and services that query and sends a response to core engine 110 with the requested information (e.g., $1,054.61).

In FIG. 4B, core engine 110 will receive the information obtained from enterprise servers 130, and response server 420 will send a response to User X through user channels 120 (e.g., “Your balance is $1,054.61.”). Response server 420 optionally can utilize templates that it populates with information obtained from enterprise servers 130 to generate its response to User X. Examples of templates are contained in Table 3:

TABLE 3
Template

Based on what you asked for, your current balance is MVR 123.99.
Your current unpaid bill amount is MVR 123.99, due 23.02.17. Just
so you know, you have a free allowance of MVR 456.88.
You have available 7.8 GB data. Last update at 23.02.17 09:00.
Your usage during last 7 days is 8 SMS. Last update at 13.03.17 14:42

In instances where core engine 110 is unable to determine the intent of the communication from User X, it can forward the communication to third-party servers 150, which in this example as shown in FIG. 4E, will result in a third-party server receiving User X communication and sending it to an actual person who is interacting with the third-party server (e.g., a customer service representative). That person can then generate a response to User X communication and either send that response directly to User X or send that response to core engine 110 and receive a recommended response to send to User X. Core engine 110 then will send that response to user channels 120. Core engine 110 will update knowledge libraries 206 with information obtained from the response.

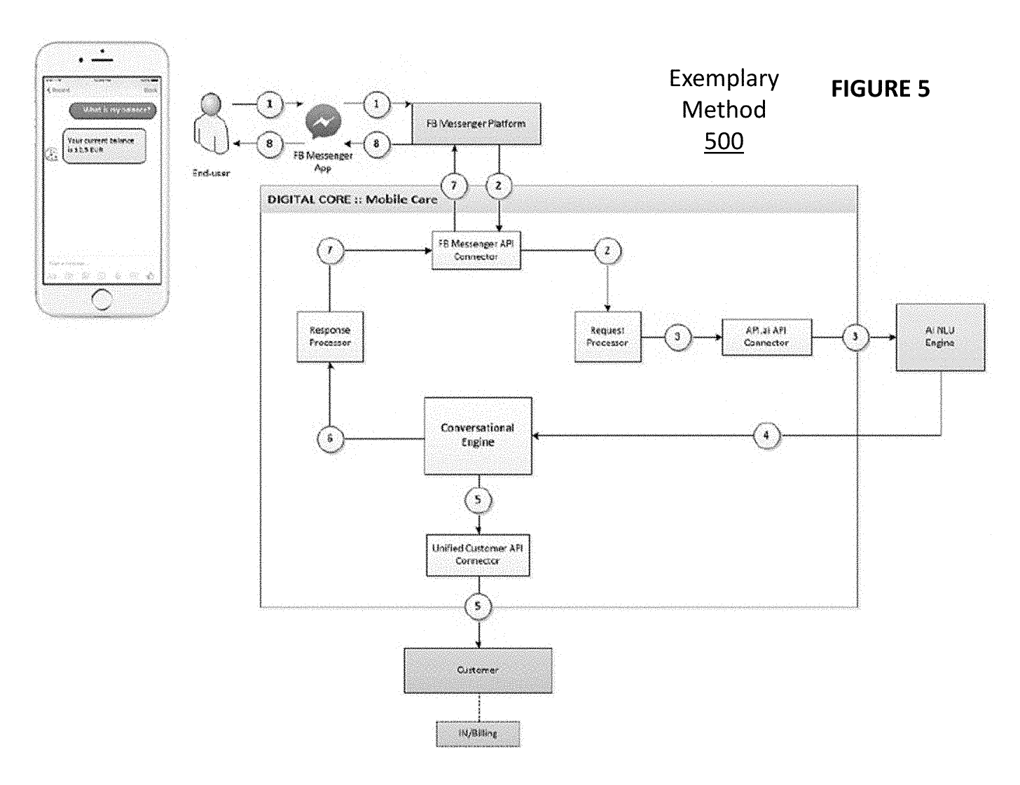

FIG. 5 depicts details of an exemplary method 500 representing an information exchange using communication system 100. The end-user sends a ‘What is my balance?” message to the Mobile Care Service (step 1). The end-user message is received by request processor 410 and it starts processing it (step 2). Request processor 410 sends a request artificial intelligence engine 140, which here comprises an artificial intelligence Natural Language Understanding (NLU) Engine to parse User X's message and identify the intent of the message (step 3). Artificial intelligence engine 410 sends back a response with the identified intent “get_balance” (step 4). Conversational Engine 201 processes the received intent, identifies a matching response using a template library, detects that the response requires additional data to be requested from Company Y, sends respective Customer API request to enterprise servers 130 for Company Y and gets the required data (12.5 ELM′—the value or the current balance for the end-user) (step 5). Conversational Engine 201 sends the response template and required data to the response processor 420 (step 6). Response processor 420 renders the response template for a facebook Messenger channel and sends it to the User X (step 7). User X receives a response from Mobile Care Service, saying ‘Your current balance is 12.5 EU’ (step 8).

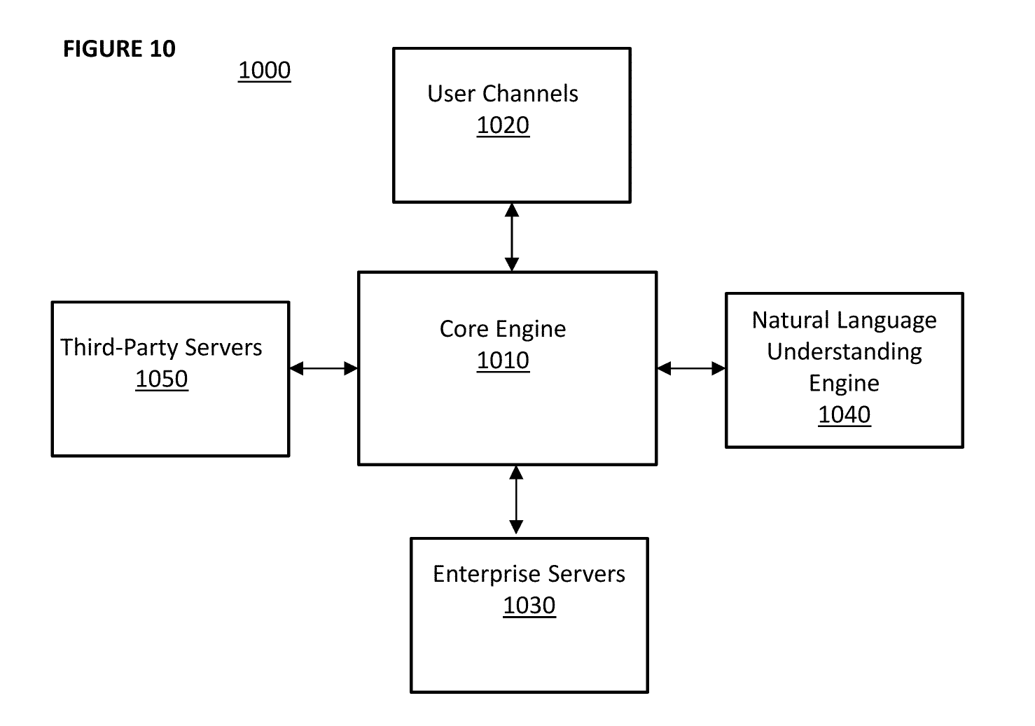

A variation of communication system 100 is shown in FIG. 10. In FIG. 10, communication system 1000 comprises core engine 1010 that interfaces with user channels 1020, third-party servers 1050, enterprise servers 1030, and natural language understanding engine 1040 over one or more networks and/or links. The primary difference between communication system 1000 and communication system 100 is the use of natural language understanding engine 1040 instead of artificial intelligence engine 140.

Core engine 1010 comprises lines of software code executed on one or more servers, each server comprising one or more processing units, memory, non-volatile storage (such as one or more disk drives or flash memory arrays), and a network interface.

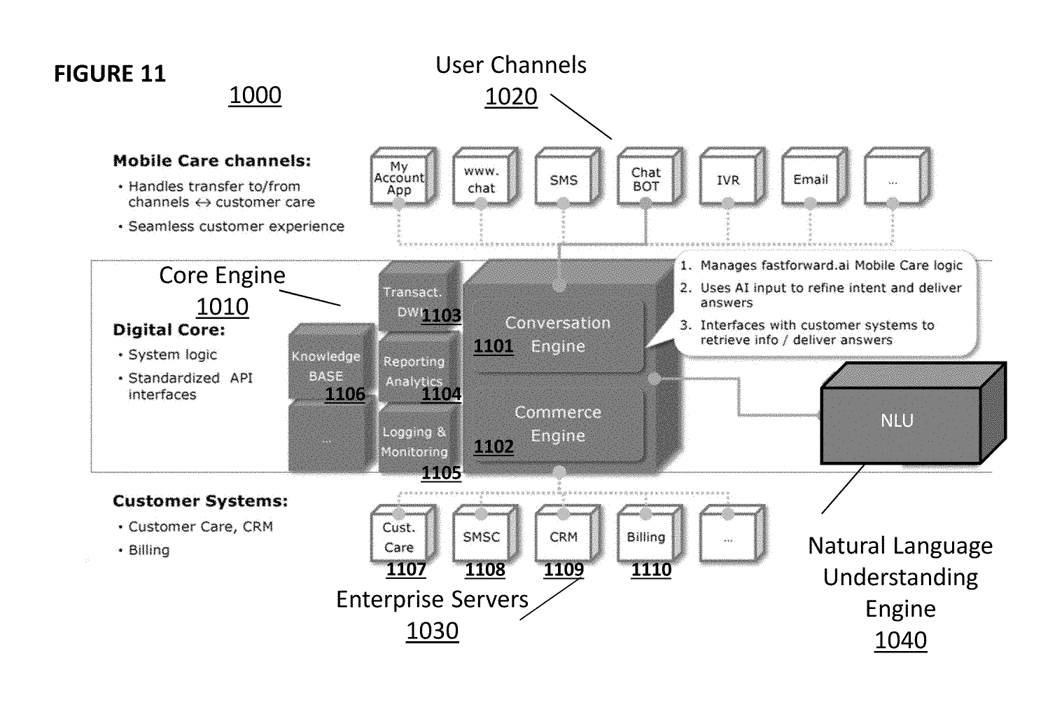

Referring to FIG. 11, additional detail is shown for communication system 1000.

Each channel within user channels 1020 comprises a user device (such as a mobile device or laptop or desktop computer) and a communication mechanism by which a user communicates with core engine 1010. Examples of communication mechanisms include software applications (“apps”), web-based chat features, SMS or MMS messaging, email, voice, or other known mediums.

Core engine 1010, similar to core engine 110, optionally comprises conversation engine 1101 (also referred to as conversational engine 1101), commerce engine 1102 (an example of which is campaign management engine 1102), transaction data warehouse 1103, reporting analytics engine 1104, logging and monitoring engine 1105, knowledge base 1106 (also referred to as knowledge libraries 1106), and other modules or engines.

Natural language engine 1040 can comprise one or more engines running one on or more servers that operate independently or in concert with one another.

Enterprise servers 1030 are enterprise servers typically operated by a large company to run its business activities. For purposes of illustration, we will assume that enterprise servers 1030 in the embodiments are operated by or for Company Y. Examples of enterprise servers 1030 include customer care server 207, SMSC (short message server center) server 208, CRM (customer relationship management) server 209, billing server 210, and other servers.

Third-party servers 1050 are not shown in FIG. 11.

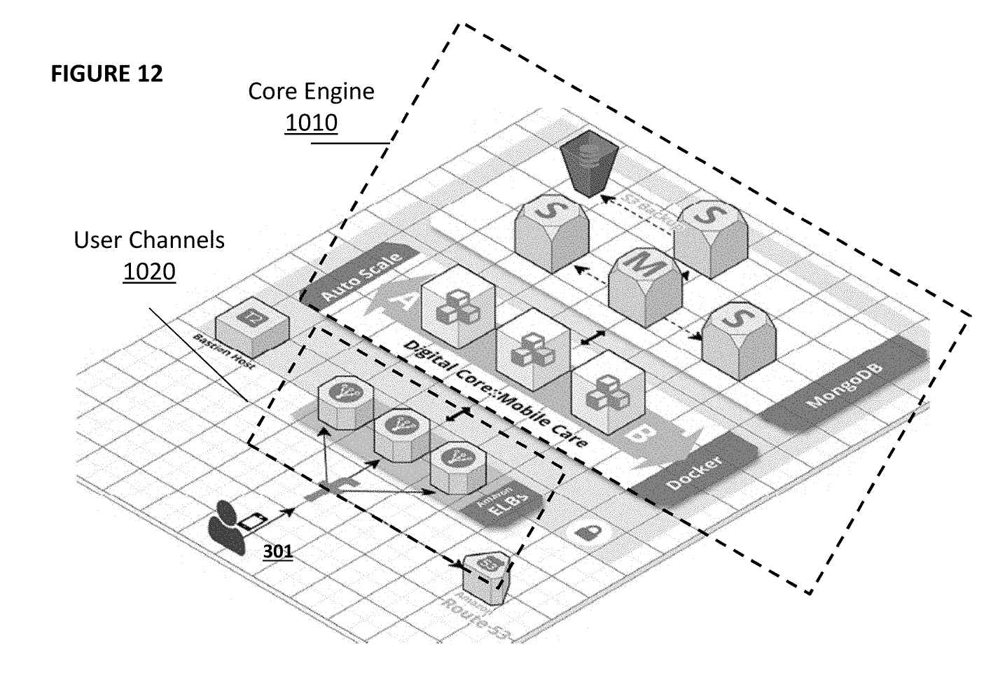

Referring to FIG. 12, additional detail is shown of certain aspects of communication system 1000. A user operates computing device 301 (such as a mobile device) and interacts user channels 1020 with one or more of the mechanisms described previously, such as a chat app. User channels 1020 are implemented by servers as depicted. Core engine 1010 is implemented by servers and database units as depicted. For purposes of illustration, the embodiments described herein will involve User X as a typical user.

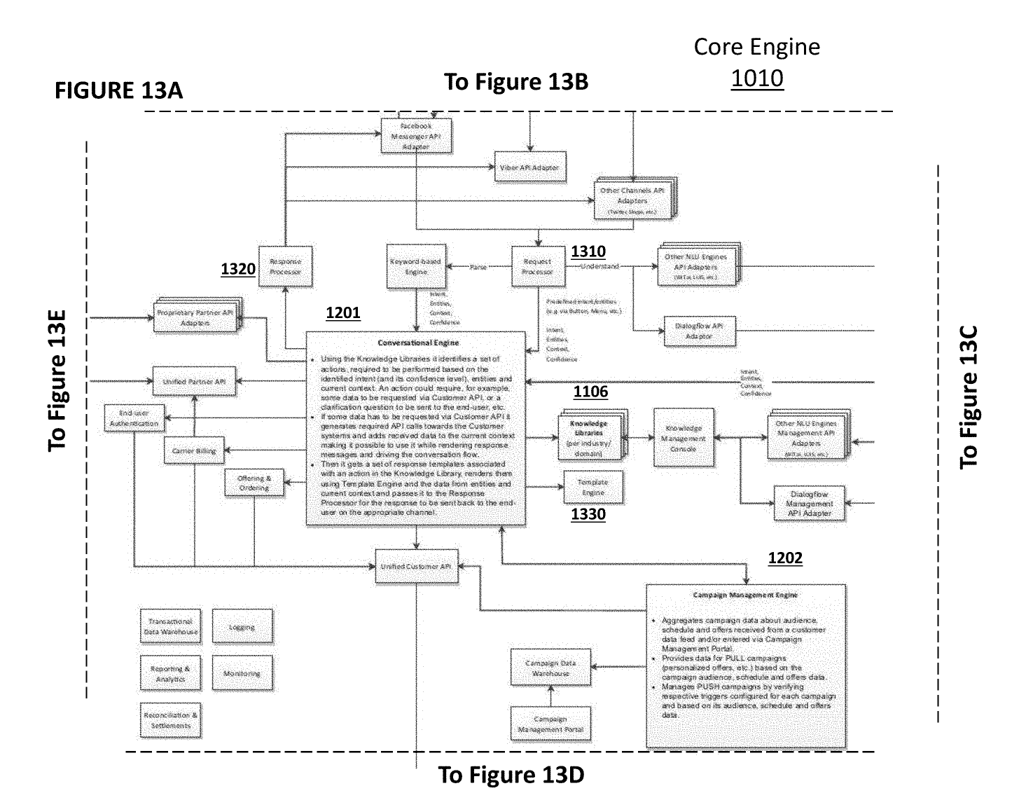

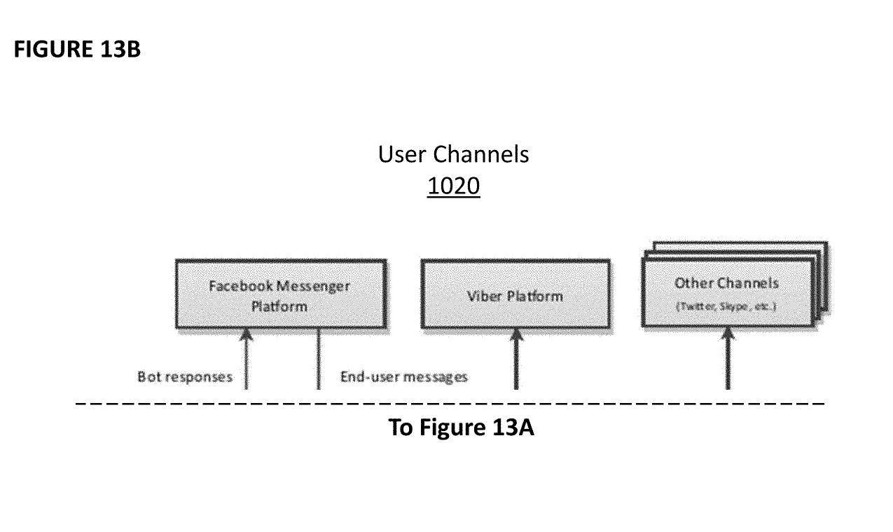

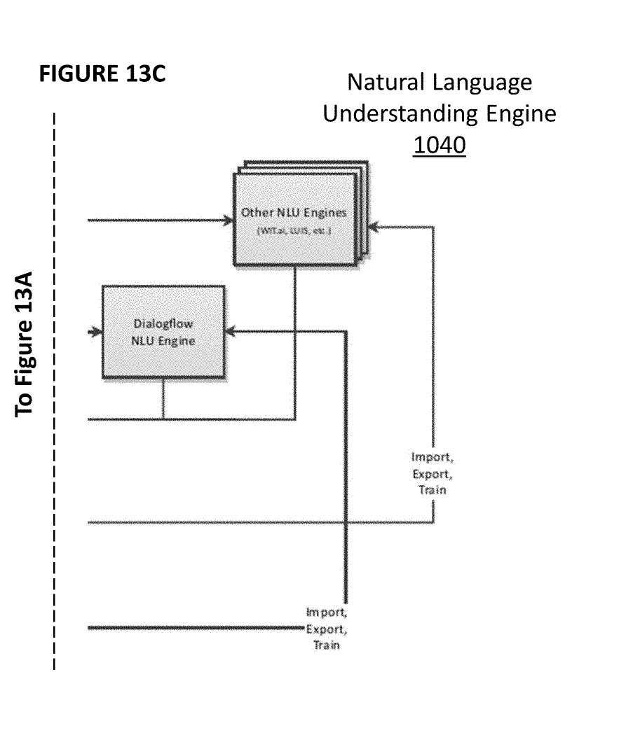

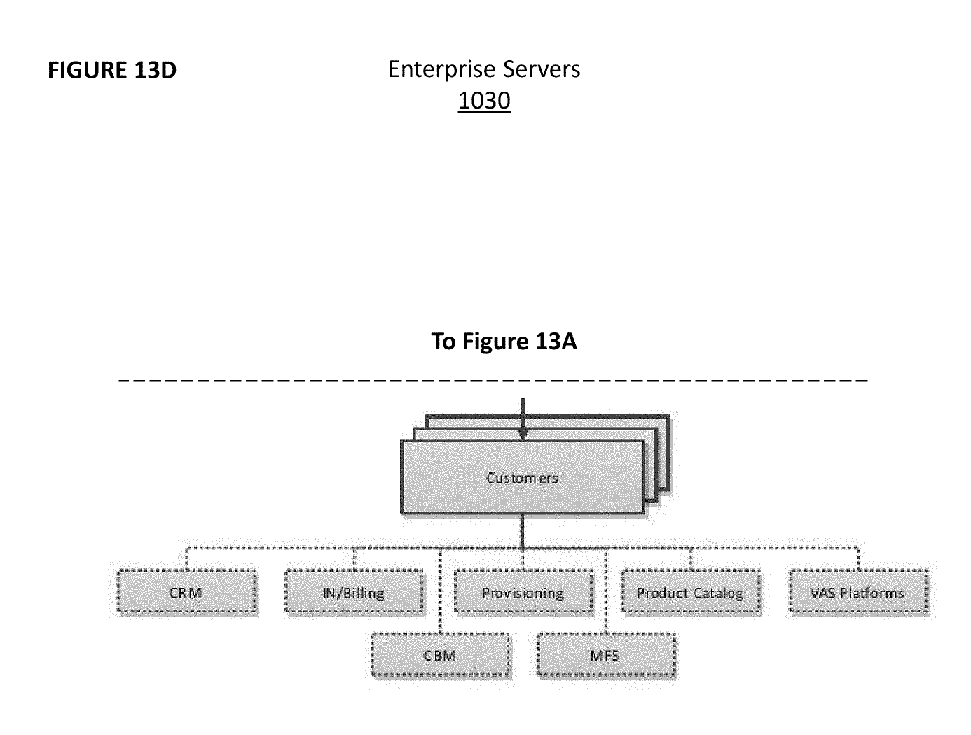

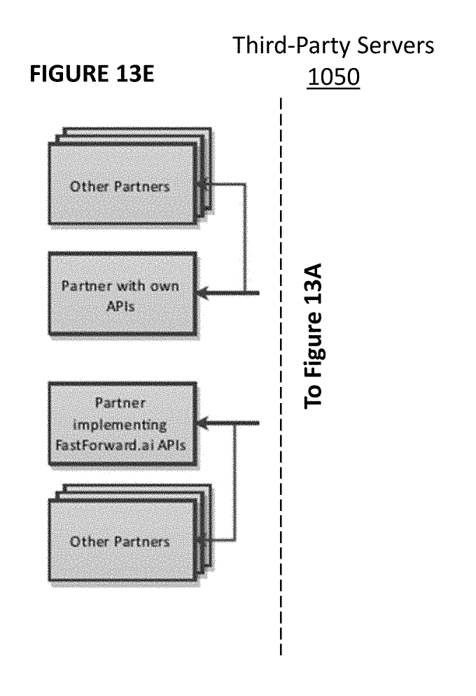

FIGS. 13A, 13B, 13C, 13D, and 13E depict additional details regarding communication system 1000. FIG. 13A depicts exemplary details of core engine 1010, FIG. 13B depicts exemplary details of user channels 1020, FIG. 13C depicts exemplary details of natural language engine 1040, FIG. 13D depicts exemplary details of enterprise servers 1030, and FIG. 13E depicts exemplary details of third-party servers 1050.

In FIG. 13B, a user engages in communication over facebook Messenger Platform, which is an example of a software app that provides a messaging service that can communicate with core engine 1010, or other exemplary channels as shown. User X will initiate communication with Company Y. From User X's point of view, he or she is attempting to communicate with a customer service representative of Company Y. Company Y might be, for example, a bank, credit card company, phone company, utilities company, airline, or any other type of company. Company Y might be the operator of core engine 1010 or it might have hired another company to operate core engine 1010 on its behalf. Thus, instead of actually communicating with a customer service representative, User X will communicate with core engine 1010.

In FIG. 13A, core engine 1010 communicates with user channels 1020. Core engine 1010 comprises connectors for communicating with each mechanism potentially operated by User X, such as a facebook Messenger API connector. This allows core engine 1010 to receive the same communications from User X that a customer service representative typically would receive.

The communications received from User X are provided to request processor 1310. Request processor 1310 will determine if it understands the communication from User X with a degree of certainty that is above a predetermined, acceptable threshold (such as 95% certainty). If User X's communication is similar to other communications that have been received and responded to in the past, such as “What is my balance?”, request processor 1310 will be able to determine the intent of this communication using knowledge libraries 1106. Knowledge libraries 1106 can comprise one or more databases or files that correlate customer intent with language. Knowledge libraries 1106 can be built over time based on actual interactions with customers. Examples of language and associated intent are shown in Table 4:

TABLE 4

| Language | Intent |
|---|---|
| Balance | User Y account balance |
| Payment Due | User Y account payment deadline |
| Account Type | User Y account type parameters |
| Usage | User Y account usage of specific Company Y |
| | services |
| Tariff | User Y account tariff info specific to |
| | Company Y services |

If request processor 1310 is able to determine User X's intent with a degree of certainty above the acceptable threshold based on the communication and knowledge libraries 1106, then it can act without communicating with natural language understanding engine 1040. However, if request processor 1310 is unable to understand the communication with a degree of certainty above the acceptable threshold, it will engage with interfaces to natural language understanding engine 1040.

In FIG. 13C, natural language understanding engine 1040 will receive the User X communication from core engine 1040 and will perform natural language understanding algorithms on the communication to determine the intent of the communication. Natural language understanding engine 1040 then will send a communication to core engine 1010 indicating the intent of User X communication (e.g., “Balance of Bank Account”). Exemplary input sets sent to natural language understanding engine 1040 and exemplary outputs received from natural language understanding engine 1040 are contained in Table 5:

TABLE 5

| | Output (Intent |
|---|---|
| Input (User X Communication) | of User X Communication) |
| What is my balance? | account balance |
| When is my bill due this month? | account payment deadline |
| How many minutes I consumed so far? | minute resource usage |
| What's to cost to call Italy? | International destination cost |

In FIG. 13B, core engine 1010—either through its own understanding without engaging with artificial intelligence engine 1040 or through communications with artificial intelligence engine 1040—will determine actions it needs to take to service User X's communication, which may involve communicating with enterprise servers 1030. For example, core engine 1010 might initiate a query to one of enterprise servers 1030 through an API or other mechanism.

In FIG. 13D, enterprise servers 1030 receive a query (e.g., an API request to obtain balance of account for User X) from core engine 1010 and services that query and sends a response to core engine 1010 with the requested information (e.g., $1,054.61).

In FIG. 13B, core engine 1010 will receive the information obtained from enterprise servers 1030, and response processor 1320 will send a response to User X through user channels 1020 (e.g., “Your balance is $1,054.61.”). Response processor 1320 optionally can utilize templates that it populates with information obtained from enterprise servers 1030 to generate its response to User X. Examples of templates are contained in Table 6:

TABLE 6
Template

Based on what you asked for, your current balance is MVR 123.99.
Your current unpaid bill amount is MVR 123.99, due 23.02.17. Just
so you know, you have a free allowance of MVR 456.88.
You have available 7.8 GB data. Last update at 23.02.17 09:00.
Your usage during last 7 days is 8 SMS. Last update at 13.03.17 13:42

In instances where core engine 1010 is unable to determine the intent of the communication from User X, it can forward the communication to third-party servers 1050, which in this example as shown in FIG. 13E, will result in a third-party server receiving User X communication and sending it to an actual person who is interacting with the third-party server (e.g., a customer service representative). That person can then generate a response to User X communication and either send that response directly to User X or send that response to core engine 1010 and receive a recommended response to send to User X. Core engine 1010 then will send that response to user channels 1020. Core engine 1010 will update knowledge libraries 1106 with information obtained from the response.

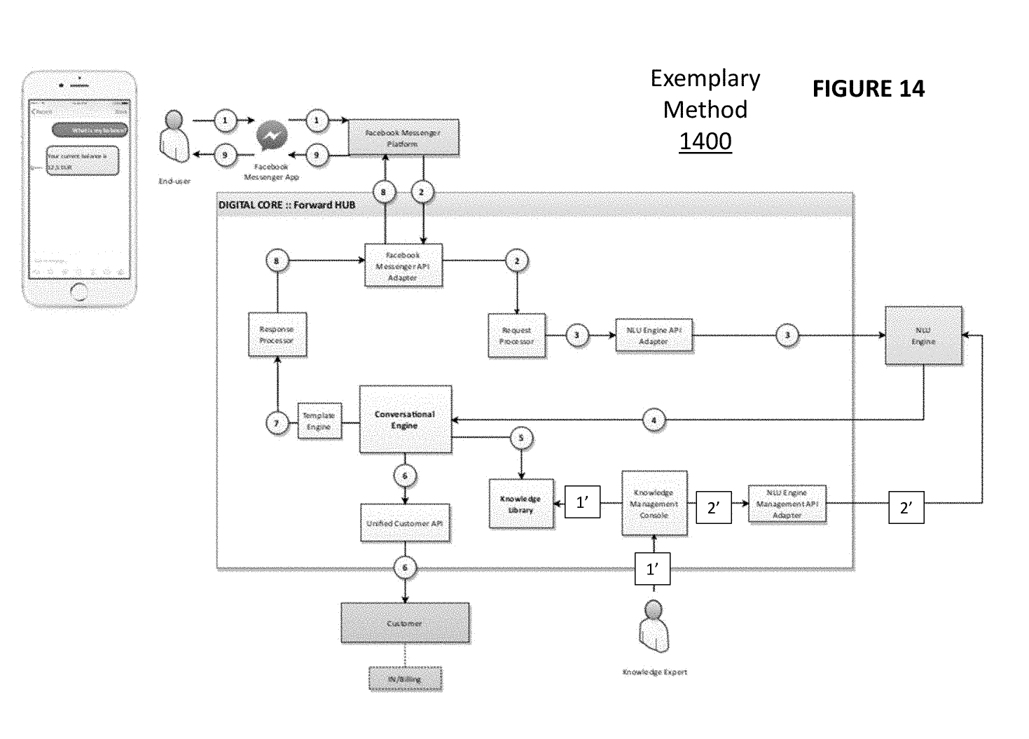

FIG. 14 depicts details of an exemplary method 1400, similar to exemplary method 500, representing an information exchange using communication system 1000. The end-user, User X, sends a ‘What is my balance?” message to the FastForward Service (step 1). The end-user message is received by request processor 1310 and it starts processing it (step 2). Request processor 1310 sends a request to natural language understanding engine 1040 to parse User X's message and identify the intent of the message (step 3). Natural language understanding engine 1040 sends back a response with the identified intent “get_balance” (step 4). Conversational engine 1101 looks up the received intent in the knowledge library 1106, identifies matching response template, and detects that the response requires additional data to be requested from the Customer, Company Y (step 5). Conversational engine 1101 sends required Customer API request and gets the required data (12.5 EUR, which is the value of the current balance for User X) (step 6). Conversational engine 1101 uses template engine 1330 to render the response template using received data from the Customer API and sends a response message to response processor 1320 (step 7). Response processor 1320 prepares a response message for a facebook Messenger channel and sends it to User X (step 8). User X receives a response from FastForward Service saying “Your current balance is 12.5 EUR.” (step 9).

In an alternative variation, a Knowledge Expert (a person) inputs exemplary conversation flows (intents, actions, parameters, response templates, message templates, etc.) into knowledge library 1106 using Knowledge Management Console (step 1′). After the conversation flows are described in knowledge library 1106, defined intents and entities are provisioned to the natural language understanding engine 1040 and are used by the conversational engine 1101 (step 2′).

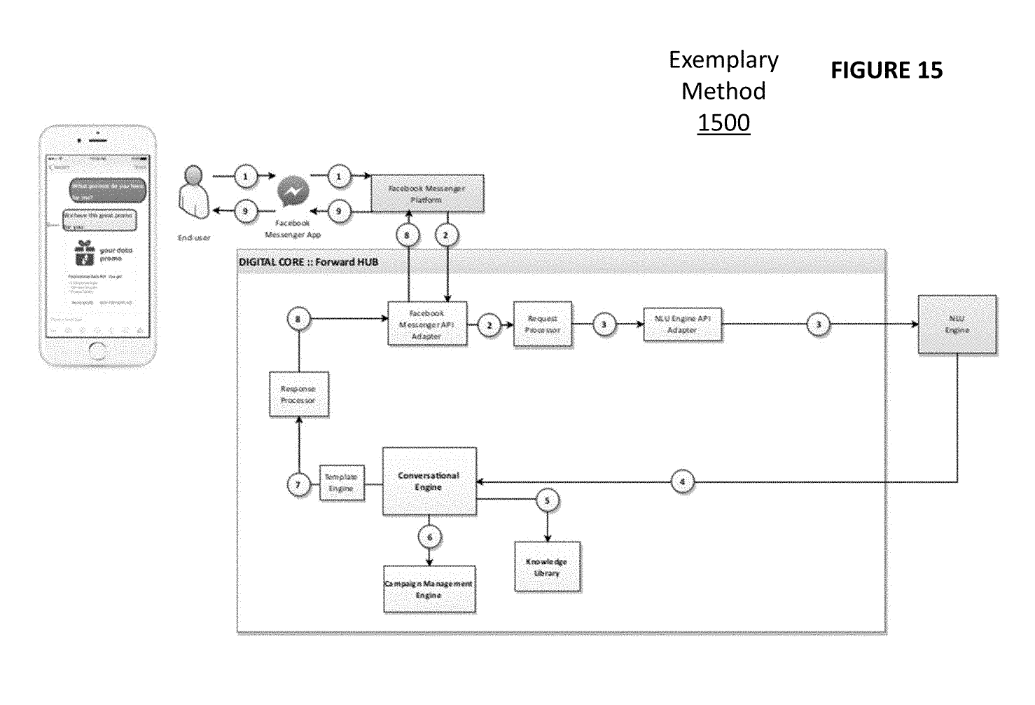

FIG. 15 depicts details of exemplary method 1500, similar to exemplary method 1400, and which depicts a “PULL” campaign using communication system 1000. The end-user, User X, sends a ‘What promos do you have for me?” message to the FastForward Service (step 1). The end-user message is received by request processor 1310 and it starts processing it (step 2). Request processor 1310 sends a request to the natural language understanding engine 1040 to parse User X's message and identify the intent of the message (step 3). Natural language understanding engine 1040 sends back a response with the identified intent “latest_promo” (step 4). Conversational engine 1101 looks up the received intent in the knowledge library 1206, identifies matching response template, and detects that the response requires additional data to be requested from the campaign management engine 1102 operated by the Customer, Company Y (step 5). Conversational engine 1101 sends a request to the campaign management engine 1102 to retrieve a personalized promo for User X and receives information about the “Promotional Data 401” promo (step 6). Conversational engine 1101 uses template engine 1330 to render the response template for “latest_promo” action using the received information about the promo and sends a response message to the response processor 1320 (step 7). Response processor 1320 prepares a response message for a facebook Messenger channel and sends it to User X (step 8). User X receives a response from FastForward Service with information about “Promotional Data 401” promo (step 9).

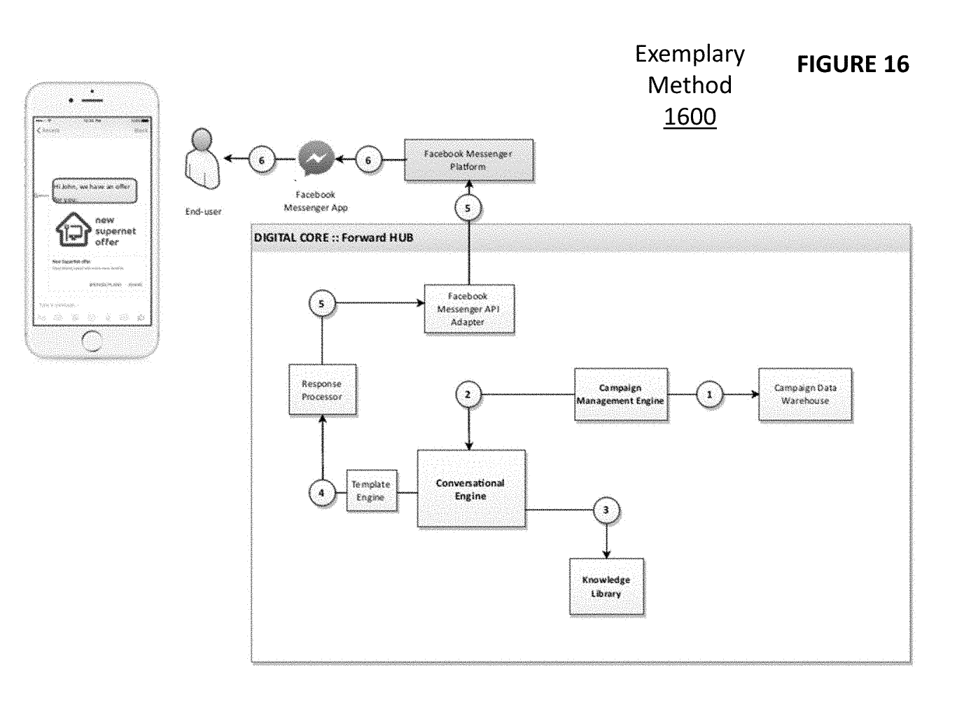

FIG. 16 depicts details of exemplary method 1600, similar to exemplary method 1400, and which depicts a “PUSH” campaign using communication system 1000. Campaign Management Engine 1102 identifies that a trigger condition for a certain campaign (“New SuperNet offer”) are met for a set of end-users meeting the audience criteria for that campaign. (step 1). Campaign management engine 1102 ends a request to conversational engine 1101 to trigger a specific action for a number of end-users (determined by the campaign audience) and provides the data to be used while rendering that action's response templates (step 2). Conversational engine 1101 looks up received action in the knowledge library 1106 and identifies matching response template (step 3). Conversational engine 1101 uses template engine 1330 to render the response template using the data received from campaign management engine and sends a response message to the response processor 1320 (step 4). Response processor 1320 prepares a response message for a facebook Messenger channel and sends it to the relevant end user (step 5). The end-user receives a response from FastForward Service with information about “Promotional Data 401” promo (step 9).

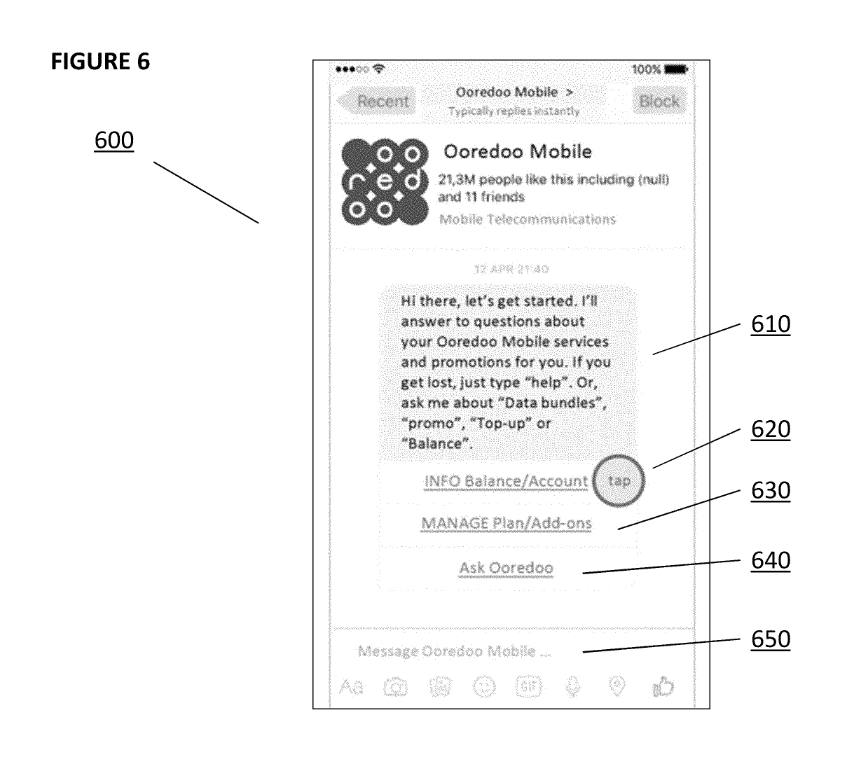

FIGS. 6-9 depict additional functionality provided by core engine 110 or core engine 1010 to User X.

FIG. 6 depicts exemplary method 600. User X initiates communication with core engine 110 or 1010 as to Company Y for the first time, after user authentication. Core engine 110 or 1010 sends User X a text communication 610 and provides user input devices 620, 630, 640, and 650. In this example, if User X taps user input device 620, User X will be provided with his or her balance or account information. If User X taps user input device 630, User X will be provided with options to manage his or her plan or to sign up for add-ons. If User X taps user input device 640, he or she will be provided with options to ask a question of Company Y. User input device 650 is a text input box, in which User X can type any request in text format.

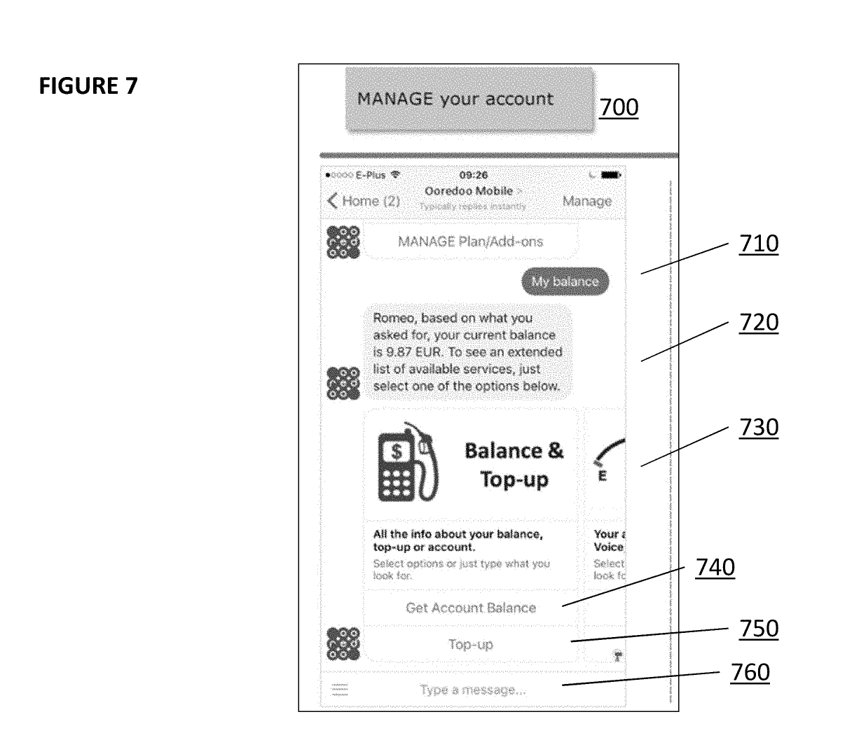

FIG. 7 depicts exemplary method 700 that might occur if User X had tapped user input device 630 in FIG. 6, to launch a “Manage Your Account” event. If user taps user input device 710, he or she will be provided with the account balance. Communication 720 is a communication formulated by core engine 110 or 1010 and provided to User X. User input device 730 provides another option for User X. If User X taps input device 740, he or she can obtain account balance. If User X taps input device 750, he or she can obtain a mechanism for topping off his account (which might be useful for a prepaid debit card, for example). User input device 760 is a text input box, in which User X can type any request in text format.

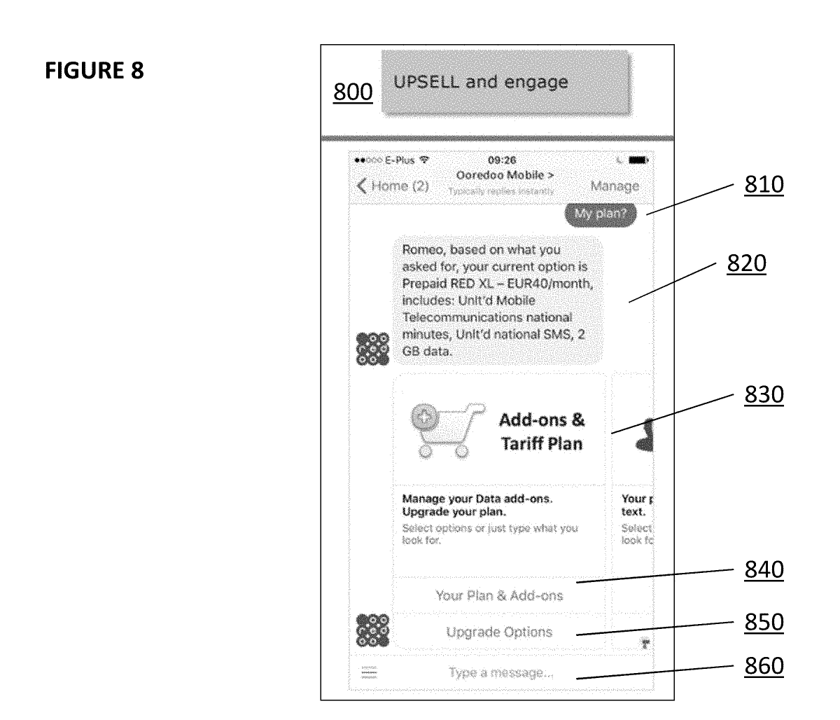

FIG. 8 depicts exemplary method 800, which illustrates the provision of “upselling” services to User X or otherwise engaging with User X. Here, User X sends a message 810 to core engine 110 or 1010. Core engine 110 or 1010 sends message 820 back to User X. User input device 830 provides another option for User X. If User X taps input device 840, he or she can obtain information about User X's plan and add-ons. If User X taps input device 850, he or she can obtain a mechanism for upgrade options. User input device 860 is a text input box, in which User X can type any request in text format.

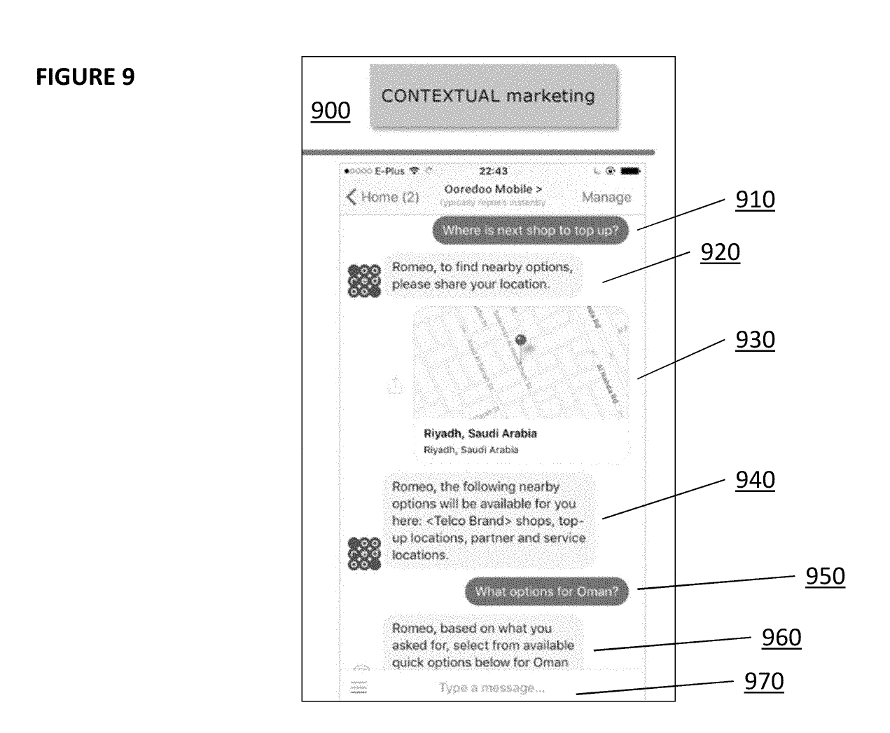

FIG. 9 depicts exemplary method 900, which illustrates the provision of contextual marketing. Here, User X sends a message 910 to core engine 110 or 1010. Core engine 110 or 1010 sends message 920 back to User X asking for User X to share his or her location, which User X can do by configuring his or her “Settings” (not shown) for the device. Core engine 110 or 1010 sends message 940 to user with options. User sends another message 950. Core engine 110 or 1010 sends message 960. User input device 860 is a text input box, in which User X can type any request in text format.

References to the present invention herein are not intended to limit the scope of any claim or claim term, but instead merely make reference to one or more features that may be covered by one or more of the claims. Structures, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between).

What is claimed is:

1. A method of automatically responding to a natural language request, comprising:
receiving, by a processor, a natural language request from a computing device;
calculating, by the processor, the degree of certainty to which an intent of the natural language request can be determined;
if the degree of certainty exceeds a predetermined threshold, determining the intent using knowledge libraries, where the knowledge libraries contain data from prior natural language requests sent to the processor;
sending a query, by the processor, to a server based on the intent;
receiving data, by the processor, from the server in response to the query; and
sending a response to the natural language request to the computing device, where the response includes some or all of the data.

2. The method of claim 1, wherein the request from a computing device is received by the processor in an SMS or MMS message and the response is sent to the computing device using an SMS or MMS message.

3. The method of claim 1, wherein the request from a computing device is received by the processor through a web-based chat session and the response is sent to the computing device using the web-based chat session.

4. The method of claim 1, wherein the query is sent using an API.

5. The method of claim 1, wherein the query is a request for financial information.

6. The method of claim 1, wherein the response comprises information regarding a product or service available for purchase.

7. The method of claim 6, wherein the information is included in the response based on location information for the computing device.

8. A method of automatically responding to a natural language request, comprising:
receiving, by a processor, a request from a computing device within a messaging application;
calculating, by the processor, the degree of certainty to which an intent of the natural language request can be determined;
if the degree of certainty exceeds a predetermined threshold, determining the intent using knowledge libraries, where the knowledge libraries contain data from prior natural language requests sent to the processor;
sending a query, by the processor, to a server based on the intent;
receiving data, by the processor, from the server in response to the query;
sending a response to the request to the computing device using the messaging application, where the response includes some or all of the data.

9. The method of claim 8, wherein the messaging application utilizes SMS or MMS messaging.

10. The method of claim 8, wherein the query is sent using an API.

11. The method of claim 8, wherein the query is a request for financial information.

12. The method of claim 8, wherein the response comprises information regarding a product or service available for purchase.

13. The method of claim 12, wherein the information is included in the response based on location information for the computing device.

14. A system for automatically responding to a natural language request, the system comprising a processor executing a program of instructions for performing the following steps:
calculating a degree of certainty to which an intent of a request from a computing device can be determined;
if the degree of certainty exceeds a predetermined threshold, determining the intent using knowledge libraries, where the knowledge libraries contain data from prior requests sent to the processor;
sending a query to a server based on the intent;
receiving data from the server in response to the query;
sending a response to the request to the computing device, where the response includes some or all of the data.

15. The system of claim 14, wherein the natural language request is contained in an SMS or MMS message and the response is sent to the computing device using an SMS or MMS message.

16. The system of claim 14, wherein the request from a computing device is received by the processor through a web-based chat session and the response is sent to the computing device using the web-based chat session.

17. The system of claim 14, wherein the query is sent using an API.

18. The system of claim 17, wherein the query is a request for financial information.

19. The system of claim 14, wherein the response comprises information regarding a product or service available for purchase.

20. The system of claim 19, wherein the information is included in the response based on location information for the computing device.
